(19) United States
(12) Patent Application Publication
(10) Pub. No.: US 2014/0067543 A1
(43) Pub. Date: Mar. 6, 2014

(54) Smart Display Media

(71) Applicant: BLINK TECHNOLOGY LIMITED, Hong Kong (CN)

(72) Inventors: Wing Fung Yu, Hong Kong (CN); Jason Felix Tsz-Kiu Chiu, Hong Kong (CN)

(73) Assignee: BLINK TECHNOLOGY LIMITED, Hong Kong (CN)

(21) Appl. No.: 13/915,308

(22) Filed: Jun. 11, 2013

(30) Foreign Application Priority Data
Jun. 12, 2012 (CN) CN201210193228.8

(51) Int. Cl. G06Q 30/02

(52) U.S. Cl. CPC G06Q 30/0267
USPC 705/14.64

(57) ABSTRACT

A method and smart media system implementation, is provided, which includes the following steps. Setting one or more media devices to show a piece of media information. The media devices are managed by a server. A mobile terminal sets the one or more neighboring media devices as the media devices associated with the mobile terminal. The mobile terminal sends information and requests for receiving detailed media information of the associated media device to the server. The server searches the detailed media information related to the associated media device, and sends the detailed media information to the mobile terminal. As a result, consumers are provided with the effective media information according to their preferences. Also, the cost of sending information to consumers is lower than other methods.

### CROSS-REFERENCE TO RELATED APPLICATIONS

This application claims priority benefit of Chinese Patent Application Number CN 201210193228.8 (Docket #BL-1-3), entitled “Smart Outdoor Media” [symbol] [symbol] , filed Jun. 12, 2012, by Yu Wing Fung [symbol] [symbol] and Chiu Tsz Kiu Jason Felix [symbol] , which is incorporated herein by reference.

### FIELD OF THE INVENTION

This invention relates to a field of communication technology. More particularly, an embodiment of this invention relates to a method and smart media system.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. The term media refers to the platform for carrying information. The platforms could be digital display devices, posters, billboards, neon lights, and/or display shows, for example. The contents of the media could be commercials, information, games, and/or entertainments, for example. The media may include outdoor media and/or indoor media. The outdoor media may include media installed along the roads in cities, highways, railways, railway stations including exits, entrances, both sides of escalators, the inside and outside train carriages, and any media installed alongside rivers and lakes, within or near public squares, architectures, and/or construction works, for example. The indoor media may be the media inside arcades, cinemas, and/or sports centers, for example. However, the present media carries information to consumers directly, and consumers can only receive information passively. Current media fail to provide personalized information.

Prior art technologies use RFID (Radio Frequency Identification) technology of the NFC (Near Field Communication) method between a mobile terminal and a media device, such as the smart media device of mobile terminal having the RFID as disclosed by the US patent application US201106635. The RFID technology utilizes radio signal identification technology between two radio communication modules. The characteristic of the RFID technology is that the information is carried by the non-contact radio frequency electromagnetic field. The effective range may be from several centimeters to several meters in depending on the circumstances. However, there are certain restrictions in applying the RFID technology as a communication method between a mobile terminal and a media device. One restriction being that there are only a few mobile terminals that are installed with an NFC module as listed on http:www.nfcworld.com/nfc-phones-list/. Prior technology using NFC wireless online technology not only increases the manufacturing and implementation cost of mobile terminals, NFC techniques also fail to work with mobile terminals without a NFC module. The increase in cost and the need for terminals with NFS modules creates to an obstacle of popularizing media devices and enhancing the functions of media devices. Also, as present media devices are usually installed in most spots in cities, regular examinations of each media device is required to check for problems. NFS techniques thus require a large operating cost to manage and repair the media devices.

In summary, the present technology has inconvenience and defects. Thus, improvements are necessary.

### SUMMARY OF THE INVENTION

For the purpose of this specification, media or commercials are referred as multi-media advertisements. The multimedia advertisement may be displayed as a printed poster or audio-video on a screen, for example. Further, detail media refer to multimedia information that includes text, photo, audio or video related to the products or service being advertised or promoted by the commercials.

To overcome the above-mentioned defects, provides a method and smart media system that provides consumers the effective media information according to the consumer's preferences. In an embodiment, the cost of installation and maintenance of the system of this specification is lower than prior art methods.

To provide lower cost multimedia advertisements, a method of smart media is provided that includes steps in accordance with a method that includes setting one or more media devices each showing a piece of media information.

the media devices are managed by a server;
a mobile terminal selects the neighboring media devices as the associated media. devices; the mobile terminal sends a message requesting information to the server, the message requests detailed media information of an associated media device;
the server searches for the detailed media information of the associated media device, and sends the detailed media information to the mobile terminal. Media information is the information broadcast by the media device, such as a advertisement. Detailed media information is the information sent by the server, in response to the user requesting more information from the media device. The detailed media information may be further details about the media information that was broadcast or may be other information. Some examples of a mobile terminal are a mobile phone, tablet computer, and laptop computer. Associated media devices are media devices that the mobile terminal has associated with the mobile terminal. The detail media information is associated with an associated media device.

In accordance with the method as set forth above, some other steps that may also be included in the method comprise:
the server sets up an web page for the media device;
the mobile terminal sends a web page request to the server for visiting the web pages of an associated media device;
the server searches the related web page of the device according to the device mark of an associated media device provided by the web page request;
the server sends the web pages for display on the mobile terminal;
the server updates the new message or vote information input by the mobile terminal in the web pages according to the message or vote commands input by the mobile terminal; or, the server surfs the commands according to the message or vote of the mobile terminal, and displays the message or vote information stored in the web pages.

The word “mark” is used to refer to an identifier. The media device, mobile terminal, the media information, the associated media information may be include identifiers or marks that are stored in the server. In an embodiment, user may vote on whether the user likes or dislikes media information, detail media information, and/or comments about the information.

In accordance with the method as set forth above, some other steps that may also be included in the method of the mobile terminal may be for selecting the neighboring media devices as the associated media devices, which may comprise:

searching the media devices that are located within a predefined distance from the current position of the mobile terminal, by utilizing the outdoor positioning technology and/or the indoor positioning technology of the mobile device and by using a database of media devices in the server;
the database includes a list of all media devices in the vicinity of the mobile device;
the mobile terminal selects from the list and sets the associated media devices in the media device list.

In accordance with the method as set forth above, some steps that may also be included in the method select the neighboring media devices as the associated media devices, the steps comprise:

the mobile terminal sets the media device that sends a marking signal as an associated media device after receiving the marking signal sent by the neighboring media device.

In accordance with the method as forth above, some steps that may also be included in the method further comprise:

the mobile terminal sends a coupon request requesting the coupon of an associated media device to the server;
the server searches the coupon mark of the device according to the device mark of associated media device provided by the coupon request;
the server searches the coupon related to the coupon mark;
the server sends the coupon to the mobile terminal.

In accordance with the method as set forth above, some steps that may also be included in the method further comprise:

the mobile terminal sends a mobile transaction request to the server for mobile terminal to perform transactions with the associated media device;
the server searches the related product or service information of the device according to the device mark of associated media device provided by the mobile transaction request;
the server sends the product or service information to the mobile terminal;
the server processes the mobile transaction according to the product or service selected by the mobile terminal and according to a payment mode, which may be selected by the mobile terminal.

In accordance with the method as set forth above, the media device comprises a monitor module; the monitor module includes at least one sensor unit and a control unit:

the media device implements a method of smart media further comprises:
the sensor unit examines the operation of each functional module in the media device, if the operation of a functional module is abnormal, the sensor sends a failure signal to the control unit;
if the control unit receives the failure signal from sensor unit, the control sends the inoperative device information to the server; if the control unit does not receive the failure signal from the sensor unit in a predefined period, the control unit sends the operative device information to the server;
if the server receives the operative device information of media device in a predefined period, the server confirms that the media device is operative; if the server does not receive the operative device information of media device in a predefined period, or the server receives the inoperative device information, the server confirms that the media device has malfunctioned. The operative device information is information that is sent to indicate that the media device operates properly, which may include a device identifier (or mark) and may include an indication that the media device operates. The inoperative device information is information that is sent to indicate that the media device does not operate properly, which may include a device identifier (or mark) and may include an indication that the media device does not operate properly, which may include an indication of which modules failed.

In an embodiment the smart media system comprises a server, at least one media device and at least one mobile terminal and the server comprise a communicates module;

the media device comprises:
a display module for displaying media information;
a communication module for communicating with the server and/or the mobile terminal;
   the mobile terminal sets or selects the neighboring media devices as the associated media devices, and sends an information request for receiving detailed media information of associated media devices to the server;
   the server comprises:
   a system management module for managing the media device;
   a media information module for storing and searching the detailed media information of a media device and sending the detailed media information to the mobile terminal after receiving the information request.

In an embodiment of the system set forth above, the mobile terminal sends a web page request to the server for visiting the web page of an associated media device;

the server also comprises an web server module that sets up the web page of media devices, and searches the web page related to the device, which is to be displayed on the mobile terminal according to the device mark of an associated media device provided by the web page request; the server further stores the new message or vote information input by the mobile terminal in the web page according to the message or vote commands input by the mobile terminal; or, the server returns the webpage according to the message or vote of mobile terminal, and displays the message or vote information stored in the web page. Where ever in this specification a webpage that is viewable by the mobile terminal is discussed, the server may send rendering information so that the mobile terminal can generate the webpage (which is the same thing as saying that the server sending rendering information for rendering an interface along with the content to populate the interface), or the server may send information for populating an interface of an application running on the mobile terminal.

In an embodiment of the system set forth above, the mobile terminal uses the outdoor positioning technology and/or the indoor positioning technology to determine the current position and to search all media devices that are within a predefined distance from the mobile terminal; the mobile terminal composes a list of all media devices within the range; the mobile terminal selects and sets the associated media devices in the media device list.

In an embodiment of the system set forth above, the media device comprises a signal sending module that broadcasts the device mark of the media device;

the mobile terminal receiving the device mark sent from the media device uses that media device as an associated media device.

In an embodiment of the system set forth above, the mobile terminal also sends a coupon request to the server for receiving a coupon from an associated media device;

the server also comprises a coupon module that searches the coupon mark related to the device mark according to the device mark of associated media device provided by the coupon request; the server searches the coupon related to the coupon mark and sends the coupon to the mobile terminal.

In an embodiment of the system set forth above, the mobile terminal also sends a mobile transaction request for the server to perform a mobile transaction with the associated media device;

the server also comprises a mobile transaction module searching product or service information related to the device according to the device mark of the associated media device provided by the mobile transaction request; the server sends the product or service information to the mobile ter and processes the mobile transaction according to the product or service and the purchase mode selected for the product or service in the product or service information by the mobile terminal.

In an embodiment of the system set forth above, the media device comprises a monitor module, the monitor module comprises at least one sensor unit and control unit;

the sensor unit uses examines the operation of each functional module in the media device, if the operation of a functional module is abnormal, the sensor unit send a failure signal to the control unit;
if the control unit receives the failure signal from the sensor unit, the control unit sends the inoperative device information to the server; if the control unit does not receive the failure signal of sensor unit in a predefined period, the control will send the operative device information to the server;
if the server receives the operative device information of media device in a predefined period, the server confirms that the media device is operative; if the server does not receive the operative device information of media device in a predefined period, or the server receives the inoperative device information, the server confirms that the media device has malfunctioned.

A personalized media information sending technology is provided in which a mobile terminal sets one of the neighboring media devices as an associated media device, and interacts with the associated media device, which does not require RFID technology. Consumers may request the server for the detailed media information of the associated media device, via a mobile terminal instead of merely receiving the media information passively, in contrast to the present technology. The detailed media information provided by the server is more effective and meets consumers' preferences than the prior art media. The mobile terminal is enabled to interact with the media device without the cost of an RFID module. Not requiring the RFID module not only lowers the cost, but also allows the smart media system to support any kind of mobile terminal that is convenient for promoting to consumers and popularizing the smart media system functionality. In an embodiment, many kinds of methods of connecting the mobile terminal with the media device are supported, which overcomes the defects of the mobile terminal failing to connect with the media device accurately, in contrast to the prior outdoor positioning technology or the present the indoor positioning technology, which could not determine the position of the mobile device accurately. In an embodiment, the mobile terminal supports processing the mobile transaction related to the associated media device, via the server. The server sends coupons according to the requests and preferences of consumers to the mobile terminal, which enhances the commercial effectiveness of media devices. Moreover, the server sets up a web page on the media device that allows the consumers to surfer the content and allows the content provider of the smart media to enhance the interactivity between the smart media system and the mobile terminals. Moreover, since the operation of each media device is automatically monitored, workers do not need to physically examine every device (or at least do not need to examiner every device as often), which could greatly lower the management and repair cost of media devices (as compared to where the system not automatically monitoring the media devices).

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 shows a block diagram of the smart media system;

FIG. 2 shows a block diagram of an embodiment of the smart media system;

FIG. 3 shows a flowchart of an embodiment of a method of using the smart media system;

FIG. 4 shows a flowchart of an embodiment of a method of using the smart media system to send detailed media information;

FIG. 5 shows a flowchart of an embodiment of a method of using the smart media to send the coupon;

FIG. 6 shows a flowchart of an embodiment of a method of using the smart media for processing a mobile transaction;

FIG. 7 shows a flowchart of an embodiment of a method of the server monitoring the media device;

FIG. 8 shows a flowchart of an embodiment of a method of using the smart media system for visiting an interactive network.

FIG. 9 shows a block diagram of an embodiment of the server hardware used in the smart media system.

FIG. 10 shows a block diagram of an embodiment of the hardware of media device used in the smart media system.

FIG. 11 shows a block diagram of an embodiment of the hardware of mobile terminal used in the smart media system.

### DETAILED DESCRIPTION OF THE INVENTION

To further understand the purposes, technologies and advantages of this invention, following are the drawings and embodiments to further explain this invention. It should be understood that the embodiments are for the illustration of this invention only, not to limit this invention.

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In an embodiment, the smart media device may be a paper poster that displays what is currently being exhibited (e.g., in a museum or elsewhere), with text saying “if you are interested in learning more, use your smart phone to . . . ,” for example. If the smart media is a paper poster, then all the steps for establishing an association between the mobile device and the smart media device are performed by hardware (e.g., the media device) installed behind the poster. For example, a short documentary, pictures, etc. can then be downloaded to the smart mobile device.

In general, the smart media is an electronic billboard, in which the bill board can be a simple paper poster or a display or screen having an electronic image (for example, the electronic display may be a liquid crystal display, light emitting diode display, a plasma screen, a cathode ray tube, and/or a projector projecting an image on a screen). In an embodiment, the remote monitor of the operational status of smart media device may be performed by the server side and/or monitoring device. Users actively control the flow of information that the user views. In an embodiment, if a mobile device does not associate itself with a smart media device, the mobile phone will never receive anything from the smart media device nor the server managing the smart media device. In an alternative embodiment, the user may be se unsolicited information by the smart media system.

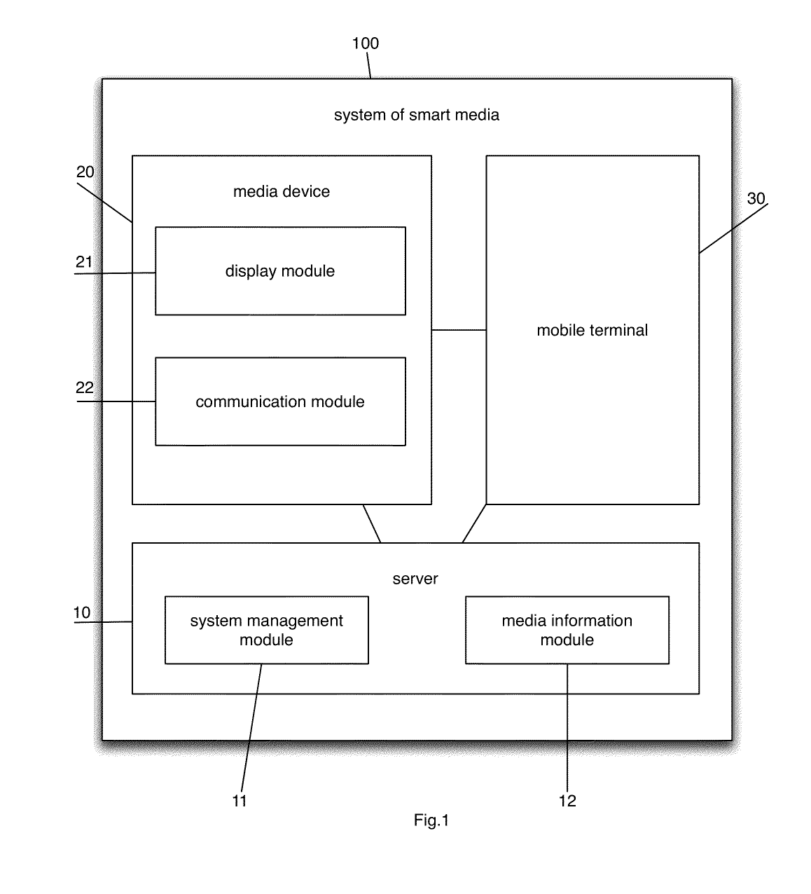

FIG. 1 is a block diagram of an embodiment of the smart media system 100. The smart media system 100 includes a server 10 having system management module 11 and media information module 12. The smart media system also includes at least one media device 20 having display module 21 and communication module 22. The smart media system 100 includes at least one mobile terminal 30. In other embodiments, the smart media system 100 may not include all of the components listed above and/or may include other components.

The media device 20 may be an electronic billboard having a static and/or electronic display. Display module 21, displays the media information. The media information could be commercials, information, games, and entertainment, etc. Display module 21 could be a digital display device, poster, billboard, neon light, display show, etc., showing the digital information or printing information for consumers. The format of the media information content could be videos, images, audios and/or text, for example.

Communication module 22 communicates with the server 10 and/or mobile terminal 30. The communication module 22 of media device 20 connects with the server 10, via the Internet, LAN (local area network), or mobile communication network.

The mobile terminal 30 selects one of the neighboring media devices 20 as an associated media device 20, and sends an information request to the server requesting the detailed media information of the associated media device. For example, if the consumer is interested in a commercial displayed by the media device 20, the consumer could send a request from the mobile terminal 30 to receive further details related to the commercial displayed on media device 20.

The server 10 may include system management module 11. System management module 11 manages media device 20. Media information module 12 stores the detailed media information and supports searching the detailed media information of a media device. For example, media information module 12 may include a search engine, database server, or other software for searching the detailed media information. Media information module 12 may send the detailed media information to the mobile terminal 30 after receiving an information request. In an embodiment, the request may include an identifier of the information (which may be referred to as a information mark) and an identifier of the device that is currently displaying related information (which may be referred to as a device mark). The media information module 12 searches the related media information mark of the device, thereby searching the detailed media information related to the media information mark according to the device mark of a media device 20 provided by the information request. Then the detailed media information is sent to the mobile terminal 30.

The mobile terminal 30 is carried and used by the consumer. A mobile terminal 30 can be a smartphone, PDA (Personal Digital Assistant), tablet, or notebook, for example. Further mobile terminal 30 can be an Apple iPhone™, Apple iPod™ Touch, Apple iPad™, Android™ cell phone, Android™ tablet, RIM BlackBerry™ cell phone, Windows Phone, Symbian™ cell phone, or other mobile terminals that are capable of operating application programming. The mobile terminal 30 includes communication module (not shown in the diagram) that communicates with the mobile communication network. The mobile terminal 30 may or may not include a positioning module to determine the position of mobile terminal 30.

The mobile terminal 30 communicates with the server 10 via the mobile communication network. The mobile communication networks include the GPRS (General Packet Radio service) network, WCDMA (Wideband Code Division Multiple Access) network, CDMA2000 (Code Division Multiple Access 2000) network, TD-SCDMA (Time Division-Synchronous Code Division Multiple Access) network, HSDPA (High Speed Downlink Package Access) network, TETRA (Terrestrial Trunked Radio) network, LTE (Long Term Evolution) network, Wireless network, WiMAX (Worldwide interoperability for Microwave Access) network, Bluetooth network or other matched communication networks. A matched communication network is a communication network whose standards are met (or matched) by the mobile terminal. The mobile terminal 30 matches at least one of the standards of the mobile communication networks. The mobile terminal 30 could communicate with the server 10 and networks by using mobile communication networks via the IP (Internet Protocol) and/or other communication protocols.

The media device 20 may be installed at a fixed location or on a mobile location. Some examples of fixed locations where media device 20 may be installed include alongside the roads in cities, squares, architectures, etc., inside arcades, cinemas, and/or sport centers. Some examples of mobile locations where media device 20 may be installed include inside or outside of vehicles such as cars, trucks railway cars, trains, ferries, planes, etc. For example, media device 20 may be installed on the side of a moving vehicle, on a cart that is moved around in a building, on a parade float, on a mobile sign hooked to a car as a trailer, and/or on a bicycle sign.

In an embodiment, when consumers are interested in the media being display on the media device 20, consumers may request the server 10 for detailed information, via the mobile terminal 30, instead of merely passively viewing or receiving what is being displayed or being broadcast. Since the users choose to view the content, the provided detailed media information is more pertinent to the customer and meets consumers' preferences. Consequently, the customer is more likely to purchase the item or service being advertised. Also, present invention enables the mobile terminal 30 to interact with the media device 20 without utilizing the RFID module. This implementation not only lowers the cost, but also supports any kind of mobile terminal that is convenient for promoting to consumers and popularizing the smart media system function.

For example, when the media device 20 of this invention is showing a commercial, consumers could download further information about the product or service according to their requests by using the mobile terminal 30 if they are interested in knowing more details about the products or services related to the commercial when they get near media device 20. As another example, when consumers are near the subway exit, the media device 20 installed near the exit shows that the neighboring cinema is showing a certain movie, and the media device 20 may show the trailer of that movie. Consumers may request the media device 20 for a free download of the MV (Music Video) of one of the theme songs of the movie.

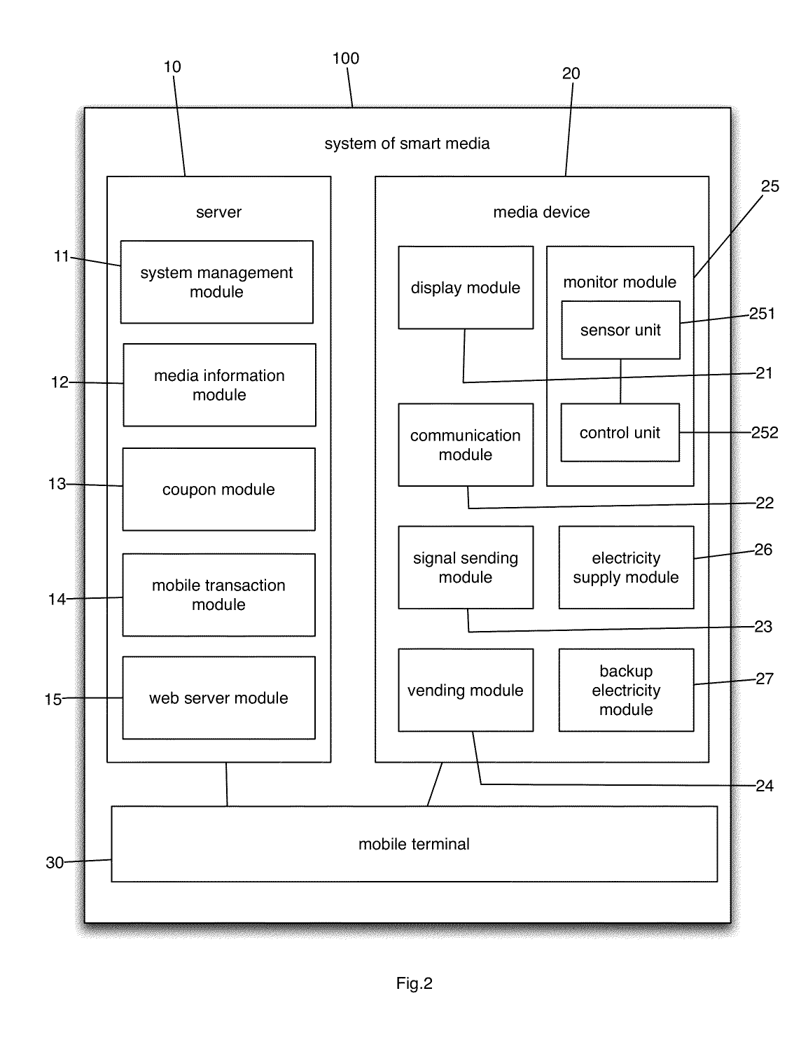

FIG. 2 is an application block diagram of an embodiment of the smart media system 100. The smart media system 100 includes a server 10 having system management module 11 and media information module 12, coupon module 13, mobile transaction module 14, and web server module 15. The smart media system also includes at least one media device 20 having display module 21, communication module 22, signal sending module 23, vending module 24, monitor module 25, electricity supply module 26, electricity supply module 26, and backup electricity module 27. The smart media system 100 includes at least one mobile terminal 30. Monitor module 25 may include sensor unit 251 and control unit 252. In other embodiments, the smart media system 100 may not include all of the components listed above and/or may include other components.

The smart media system 100, server 10, system management module 11, media information module 12, media device 20, and mobile terminal 30 were discussed in conjunction with FIG. 1. The discussion in FIG. 1 is also applicable to FIG. 2 and the discussion of FIG. 2 is applicable to FIG. 1.

Display module 21 displays the media information, which may be commercials, information, games, and/or entertainments, for example.

Communication module 22 communicates with, and/or facilitates communicating with, the server 10 and/or mobile terminal 30. The communication module 22 of media device 20 connects with the server 10 via the Internet, a LAN (local area network) and/or a mobile communication network, for example.

The mobile terminal 30 sets the neighboring media device 20 to be an associated media device 20. Mobile terminal 30 sends to the server 10 an information request for detailed media information related to information displayed on the associated media device.

System management module 11, manages the media device 20. The system management module 11 stores the media device data of each media device 20. The system management 11 module manages the media device 20 according to the media device data. The media device data comprises the device mark of media device 20, whether the media device 20 is installed in a fixed platform or a mobile platform, the longitude, latitude, height ordinate of the fixed platform, and the address of media device 20. The media device data may also include an indication of whether the media device 20 includes a vending machine, the schedule of media being displayed, and the associated media mark. The media device data may also include the coupon mark associated with the displayed media mark and the operation status of media device 20.

Media information module 12 stores and searches the detailed media information of the associated media device 20. Media information module 12 sends the detailed media information to the mobile terminal 30 after receiving the information request from mobile terminal 30. The media information module 12 stores the media information data. The media information data may include the media mark and the detailed media information. The detailed media information may include texts, multimedia data, and/or the websites' hyperlinks, for example.

Mobile terminal 30 identifies and links with an associated media device 20.

In one embodiment, the mobile terminal 30 uses the outdoor positioning technology and/or the indoor positioning technology to determine it's current position and search all media devices 20 within a predefined distance from the mobile terminal 30. Based on the search, mobile terminal 30 composes a list of media devices. The mobile terminal 30 selects and sets the associated media devices 20 from the media device list.

The mobile terminal 30 determines the current position of mobile device 20. The positioning module of mobile device 30 determines the position of the mobile terminal 30, via the outdoor positioning technology and/or the indoor positioning technology. The application program of mobile terminal 30 may call the internal positioning function on of mobile terminal 30, including GPS and Assisted GPS. The mobile terminal 30 connects with the media device 20 when media device 20 is within a predefined distance from mobile device 30. For example, the predefined distance could be 30 ft. Since the GPS system requires communicating with several positioning satellites at the same time, and since reception of the satellite signals may be degraded within buildings, GPS is more suitable for the media device 20 installed outdoors, but may be used indoors, also.

The application programming of mobile terminal 30 could also calculate a more accurate positioning itself that depends on, but is not limited to, the indoor wireless network positioning, neighboring ultrasound positioning system (patent application in China, CN201210030372.X, U.S. Ser. No. 13/763,275), terminal permission verification positioning system (patent application in China, CN201210129060.4, U.S. Ser. No. 13/872,959), wireless network SSID positioning (patent application in China, CN200810100327.6). Bluetooth beacons, mobile network transmitter, etc. More than one of the above-mentioned positioning methods may be used by mobile terminal 30 and/or smart media device to enhance the accuracy. If there is only one media device 20 within a predefined distance, the mobile terminal 30 will connect with the media device 20. Generally, indoor positioning provides a more accurate determination of positioning for matching positions of the mobile terminal with indoor media devices 20.

In an embodiment where the indoor positioning method is used by mobile terminal 30, media device 20 may include the indoor positioning fixed device to broadcast position information to mobile device in the vicinity. To accommodate a mobile terminal 30 that uses neighboring local ultrasound positioning system, the media device 20 may include an ultrasound positioning system for transmitting positioning information. To accommodate a mobile terminal 30 that uses the Bluetooth beacons system, the media device 20 may include a Bluetooth beacons system that uses Bluetooth signals for positioning.

The internal positioning function or the positioning calculation function of mobile terminal 30 displays the list of all media devices 20 within a predefined distance (such as 1,500 ft), and displays the related media information of media device 20. The associated media device 20 is selected, by the consumer, from the media device list.

In another embodiment, the media device 20 comprises the signal sending module 23 sending a signal having a media device mark. After receiving the device marks, the mobile terminal 30 uses the media device marks for setting the media device 20 to be an associated media device 20. Using the device mark sent by media device 20 does not depend on the position of the mobile terminal 30 that associates with a media device 20. Instead, the different embodiments of signal sending module 23 of the media device 20 includes the ultrasound transmitter sending the device mark of media device 20 by ultrasound, the wireless network sending the device mark by SSID, and/or the Bluetooth sending the media mark by Bluetooth information etc. The mobile terminal 30 connects with a selected and/or nearby media device 20 after receiving the first valid device mark. Connecting with a selected and/or nearby media device 20 after receiving the first valid device mark, is particularly useful when media device 20 is installed on a mobile platform, such as inside a ship, where positioning is not required to select nearby media devices 20.

In an embodiment, the mobile terminal 30 also sends a coupon request to the server 10 for receiving coupons from associated media device 20.

The server 10 may also include a coupon module 13. The coupon module 13 stores the coupon's data, including the coupon mark, the detailed information of the coupon, etc. The detailed information of the coupon may include texts and multimedia, websites' hyperlinks, and/or the expiry date of the coupon etc. The coupon module 13 uses the device mark provided by the coupon request to identify a currently available coupon mark and in turn uses the coupon mark to retrieve the coupon. After retrieving the coupon, the server 10 sends the coupon to the mobile terminal 30. Since the coupon was requested by the customer, the likelihood that the coupon will be used is higher.

Moreover, the mobile terminal 30 may also send mobile transaction requests to the server 10 for performing a transaction with the associated media device 20. For example, a consumer could initiate a purchase of goods or tickets to an event.

The server 10 may also comprise a mobile transaction module 14. The mobile transaction module 14 communicates with the mobile terminal 30, via the mobile communication network. The mobile transaction module 14 stores information about products or services that are available for purchase via a media device 20, such as the name, a description, an image, and/or a price of the product or service. Mobile transaction module 14 may retrieve a list of products and services by the media mark provided by the mobile transaction request. The list is then sent by the mobile transaction module 14 to the mobile terminal 30. After receiving a selection of a product or service on the list and request to purchase the product or service selected the mobile transaction module 14 processes the mobile transaction according to the product or service and a purchase mode selected in the product or service information by the mobile terminal 30.

The mobile transaction methods may include a combination of at east four modes of operating.

In an embodiment, the media device 20 may include a vending module 24. The vending module 24 could be a vending machine. The vending machine's control circuit may be directly connected to the media device 20. The vending module 24 communicates with the server 10, via the communication module 22 of the media device 20. The mobile transaction module 14 can directly issue commands to vending module 24 of media device 20 to dispense product or service tickets. The product or service purchased by the customer is one that is supported (e.g., sold) by the vending module 24. The mobile transaction module 14 confirms the mobile transaction and charges the mobile terminal 30 for the transaction fees after the vending module 24 confirms that the product dispensed is completed.

In an embodiment, the media device 20 does not include a vending module 24 and/or the product or service purchased by the customer is not supported by the vending module 24. The mobile transaction module 14 communicates with retailer's system for purchase and delivery of the product or service, including sending the delivery address and contact information of the customer. The mobile transaction module 14 confirms the mobile transaction and charges the mobile terminal 30 for the transaction fees when the retailer system confirms that the product delivery is scheduled.

In an embodiment, the media device 20 includes a vending module 24. and the product or service purchased by the customer can be dispensed with a voucher, such as a ticket to an event or redemption of products at a certain desk at a particular location. The mobile transaction module 14 issues commands to vending module 24 of media device 20 to dispense the voucher and send purchase information to the external retailer's system to update the inventory status or event status associated with the purchase. The mobile transaction module 14 confirms the mobile transaction and charges the mobile terminal 30 for the transaction fees when vending module 24 confirms that vouchers was dispensed.

In an embodiment, the media device 20 does not include a vending module 24 and the product or service purchased by the customer can be dispensed with an electronic voucher, such as a ticket to an event or redemption of products at a certain desk at a particular location. The mobile transaction module 14 issues the electronic voucher and sends the electronic voucher, by server 10, to mobile device 30, via a mobile communication network. The mobile transaction module 14 further sends purchase information to external retailer's system to update the inventory status or event status to reflect that the transaction took place. The mobile transaction module 14 confirms the mobile transaction, and charges the mobile terminal 30 for the transaction fees.

In an embodiment, after the mobile transaction is completed, the mobile transaction module 14 also sends the rewards related to the mobile transaction to the mobile terminal 30 according to the predefined reward rules. For example, transaction module 14 may send a reward of a predefined product or service coupon to the mobile terminal 30 when the consumer's purchase meets the requirement that the product amount or the price be over a predefined threshold. After the mobile transaction is completed, the mobile transaction module 14 may communicate with the coupon module 13, via a LAN or via an encrypted Internet message to notify the coupon module 13 to send the coupon related to the mobile transaction to the mobile terminal 30 according to the predefined reward rules.

Moreover, the server 10 may also comprise a web server module 15, which sets up a web page for media device 20.

The mobile terminal 30 may also send a web page request to the server 10. The webpage request may request to visit the web page of the associated media device. In an embodiment, consumers are required to input an account and/or password for identification and/or verification.

The web server module 15 stores web pages of the device. The webpages can be surfed by the device mark of the associated media device 20, which is provided by the web page request. The web server module 15 may send information that causes the display of the results on the mobile terminal 30. The web server module 15 may function as a bulletin board that allows customers to view messages or opinions left by other customers. Web server module 15 may include a webpage with fields for leaving messages or opinions on the web page related to the associated media device about products and services offered for others to view. Such opinions may be expressed in the form of a vote on certain issues.

In an embodiment, the web pages served by web server module 15 are based on the Web2.0 for consumers in the vicinity of the media device 20. The web page of a media device 20 could further interact with other web sites, but also could interlink with web pages of other media devices to form an independent web site of the same establishment, such as the same city. Thus, the consumers are not only the surfers, but are the contents' contributor of the smart media, which may enhance the interaction between the smart media system 100 and consumers.

Specifically, the web server module 15 may provide interactive functions, including functions for leaving messages or voting. The interactive functions may include fields and links that the consumers may use to upload words, images, videos etc., via the mobile terminal 30, and the voting function allows consumers to input ratings, discussions, for or against an issue, etc. This messaging and voting may be related to the media displayed on the media device 20. The web page server module 15 of server 10 may support multiple choices for the voting function. The mobile terminal 30 may select to download further information and also access the web page set up by the media device 20 to leave messages or vote, and surf others' messages or voting etc., after connecting with the associated media device 20. The interactive functions may enhance the variety of the interactive network content set up by the media device 20.

Moreover, the media device 20 may also include a monitor module 25. The monitor module 25 includes at least one sensor unit 251 and a control unit 252.

In an embodiment, the sensor unit 251 is used for the real-time examination of the operation of each functional module in the media device 20, such as examining the operations of display module 21, communication module 22, and/or vending module 24. If the operation of a functional module is abnormal, it will send a failure signal to the control unit 252.

After receiving the failure signal from sensor unit 251, control unit 252 sends information about the inoperative device to the system management module 11 of server 10. Further, in an embodiment, if control unit 252 does not receive any failure signal from sensor unit 251 in a predefined period of time, control unit 252 sends information about operative devices to the system management module 11 of server 10. Alternatively, if control unit 252 does not receive any signal from sensor unit 251 in a predefined period of time indicating that the media device 20 is operational, control unit 252 sends information indicating that media device 20 is not operative to the system management module 11 of server 10. The predefined period could be set as 30 minutes. In an embodiment, the operative device information or the inoperative device information is transmitted to the system management module 11 of server 10 in a non-text form via the UDH (User Data Header) of a short message. The UDH could also carry the device mark of media device 20. The operative device information or the inoperative device information may be transmitted to the system management module 11 of server 10, via the communication module 22 (a separate communication unit could surely be set in the monitor module 25 for redundancy purpose) in XML (eXtensible Markup Language). The XML could also carry the device mark of media device that the information is about.

In an embodiment, if the system management module 11 of server 10 receives the operative device information of media device in a predefined period, the system management module 11 confirms that the media device is operative. If the system management module 11 of server 10 does not receive the operative device information of the media device in a predefined period of time, or the server receives the inoperative device information, the server confirms that the media device 20 is in a failure mode. For example, if the monitor module 25 of media device 20 is scheduled to send the operative device information every 30 minutes, the system management module 11 will confirm that the media device 20 is in a failure if system management module 11 has not received operative device information for media device 20 for more than 40 minutes. If system management module 11 has not received operative device information for media device 20 for more than the predetermined amount of time, the system management module 11 may send an alarm signal automatically to remind workers to examine the media device 20. The system management module 11 may also update the device operation status information of media device 20. An indication that media device 20 is not operative may replace a requirement to schedule routine check up on each media device 20. Thus, by automatically checking whether or not media device 20 is operative enhances the repair efficiency and lowers the maintenance cost of media devices 20, because workers do not need to check the operation of media device 20 as often and workers are alerted that media device 20 is inoperative before the workers inspect media device 20.

There are different types of sensor unit 251 that may be used in monitor module 25. The sensor unit 251 comprises the light sensor, circuit sensor, and/or humidity sensor.

The light sensor receives the light producing information of media device 20. If sensor 251 includes a light sensor, sensor unit 251 sends a failure signal to the control unit 252 if the light producing information is abnormal. The light sensor is installed in a location where that light sensor can receive the light produced by the display module 21 of media device 20. If the display module 21 remains the same brightness or is dark for a long period, the light sensor will send a failure signal to the control unit 252 of monitor module 25.

The circuit sensor detects the circuit signal of each functional module of media device 20. For example, the circuit sensor may sample the signal in each circuit and measure the voltage and/or current, amplitude, and/or the frequency of the signal. The signal detected may be compared to an expected signal. The entire signal may be compared to the expected signal and/or certain characteristics of the signal may be compared. The circuit will send a failure signal to the control unit 252 if the circuit producing information is abnormal. The circuit sensor may include a direct current circuit sensor or an alternating current circuit sensor. According to the signals sent by the display module 21, communication module 22, signal sending module 23, vending module 24 of media device 20, the circuit sensor analyzes each of the functional modules and sends a failure signal to the control unit 252 of monitor module 25 if any of the functional modules are out of order (in an alternative embodiment, instead of detecting the signal from each module, the signal of any combination of functional modules may be detected and analyzed).

The humidity sensor detects the humidity inside the media device 20. The humidity sensor sends a failure signal to the control unit 252 if the humidity of media device 20 reaches the predefined humidity threshold.

Moreover, the media device 20 may also include an electricity supply module 26 supplying electricity to the media device 20 and a backup electricity module 27. Electricity supply module 26 and backup electricity module 27 may include a power supply, battery and/or generator.

The sensor unit 251 also sends an electricity supply failure signal to the control unit 252 when examining the operation of electricity supply module 26 is abnormal. Furthermore, when using the circuit sensor to monitor the electricity supply module 26 of media device 20, the circuit sensor will send the electricity supply failure signal to the control unit 252 of monitor module 25 if the electricity supply module 26 is out of order.

The control unit 252 also controls the backup electricity module 27 supplying electricity to the media device 20 based on the electricity supply failure signal. The backup electricity module 27 could be a capacitive backup battery charger, rechargeable battery, ordinary battery, and/or generator, for example. Backup electricity module 27 may provide electricity to media device 20 after the normal electricity supply has stopped for a sufficient amount of time for the monitor module 25 to send the inoperative device information to the server 10.

In an embodiment, the major functions of the application program running on mobile terminal 30 are:
The application programming provides a method of association between the mobile terminal 30 and a neighboring media device 20.
Consumers request the API (Application Programming interface) for further information of the media displayed by the associated media device 20 and download the further media information to the mobile terminal 30, via the communication between the mobile communication network from the media information module 12 of server 10.
The API displays the downloaded media information, and visits the related websites directly by viewing the web pages at the websites' hyperlinks included in the detailed media information.
Consumers request the API for the coupon as displayed by the associated media device 20, so that the consumer may download the coupon to the mobile terminal 30, via the communication between the mobile communication network and the coupon module 13 of server 10.
The application programming has an interface to store and display the downloaded coupon, and deletes the related coupon when the coupon is expired or used.
The application programming provides an interface for making a mobile transaction. The mobile terminal 30 connects to the mobile transaction module 14 of server 10 to display products and services and provides an interface for consumers to select. The real-time mobile transaction may proceed after the consumers confirm that the selected products or services and the selected payment method (e.g., which credit card) are the products or services and payment that the consumer intended to select. If the media device 20 is installed with a vending machine, the displayed commercial information could be related to the selling of products via the vending machine. In one embodiment, the vending machine sells canned drinks. The vending machine may dispense a canned drink after the mobile device 30 transmits the purchase confirmation to mobile transaction module 14 of server 10, via the mobile communication network, when mobile transaction module 14 confirms having received or authenticated the payment of the consumer by credit card or other payment method. Products sold by the vending machines may also be digital electronic products. If the media device 20 is not installed with a vending machine, the purchased products would be physically delivered or the purchased services would be vouchers (e.g. catering service) sent to the mobile terminal 30.
The application programming processes and displays the coupon in the mobile terminal 30 based on the amount and the price of the successful mobile transaction.

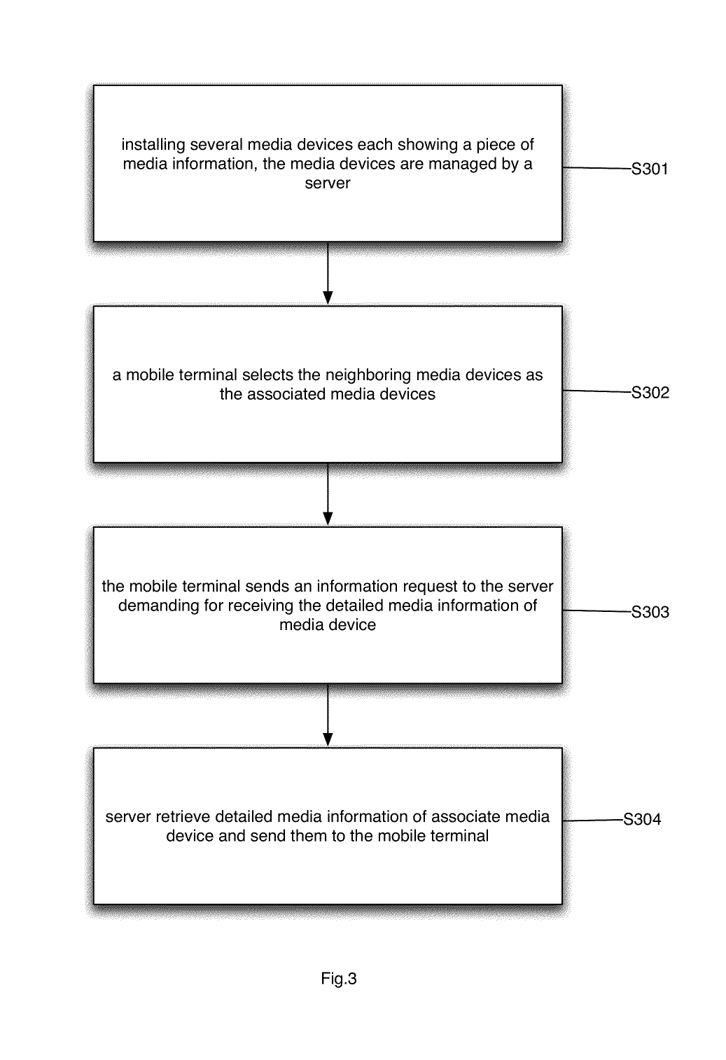

FIG. 3 is the flowchart of an embodiment of a method of smart media that could be implemented by the smart media system shown in FIG. 1 or FIG. 2, steps in accordance with the method comprise:

In step S301, several media devices 20 are each installed displaying media information. The media device 20 is managed by the server 10. The media device 20 may be installed in a fixed platform or a mobile platform.

In step S302, the mobile terminal 30 selects the neighboring media devices 20 as the associated media devices 20.

There are at least two ways to establish an association between a media device 20 and a mobile device 30.

The media devices 20 are searched by the mobile terminal 30, via the outdoor positioning technology and/or the indoor positioning technology. The search looks for those media devices 20 that are located within a predefined distance. The mobile terminal 30 then composes a list of media devices. The mobile terminal 30 selects and sets the associated media device 20 from the media devices list.

The mobile terminal 30 listens to any media device 20 sending signals carrying the media device mark, and the mobile terminal 30 selects that signal as an associated media device 20.

In step S303, the mobile terminal 30 sends an information request to the server 10 requesting detailed media information of the associated media device 20.

In step S304, the server 10 searches the detailed media information related to the associated media device 20, and sends the detailed media information to the mobile terminal 30.

The media information could be commercials, information, games or entertainments. In one embodiment, the media device 20 is a sign posted on a wall at a subway exit showing direction to a nearby museum. Further information may be downloaded by mobile terminal 30, which includes information about the exhibit themes of several exhibitions of the current museum. In another embodiment, a media device 20 shows information of a game, where the game could be a treasure hunt in a city. Consumers may gain the indications and tips of the game in different media devices 20 or download the new game to the mobile terminal 30. Purchases may be required for some additional tips, via the mobile transaction module. In yet another embodiment, a media device 20 may be installed near a cinema where a commercial about a movie is shown on the media device 20, mobile terminal 30 can request the download of a trailer or sample of theme songs, or purchase songs or MV (Music Video) of the songs of the movie, via the mobile transaction.

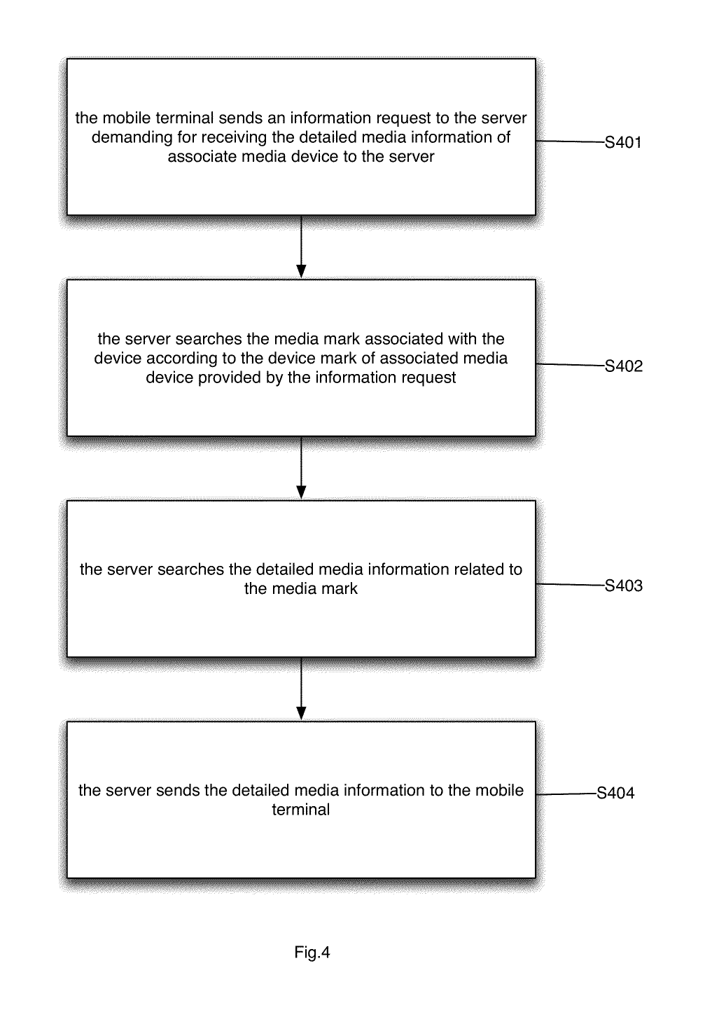

FIG. 4 is the flowchart of an embodiment of a method of sending the detailed media information that could be implemented by the smart media system shown in FIG. 1 or FIG. 2, the steps comprise:

In step S401, the mobile terminal 30 sends an information request to server 10 for receiving the detailed media information of an associated media device 20.

In step S402, the server 10 searches for the media mark associated with the device based on the device mark of the associated media device 20 provided by the information request.

In step S403, the server 10 searches for and retrieves the detailed media information related to the media mark.

In step S404, the server 10 sends the detailed media information to the mobile terminal 30.

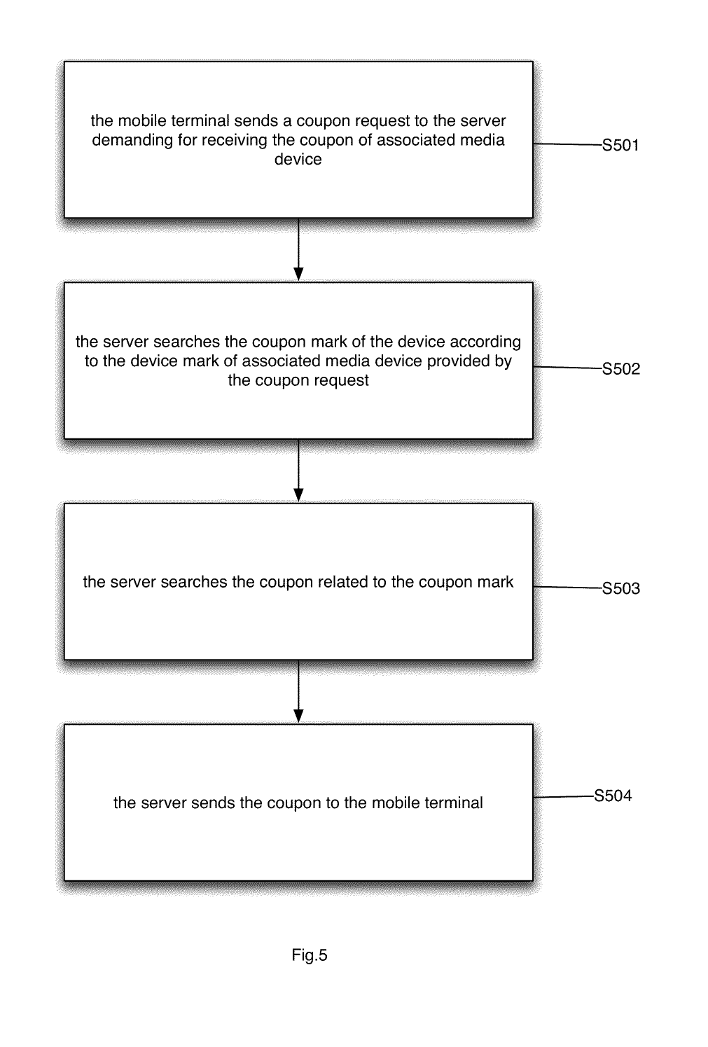

FIG. 5 is the flowchart of an embodiment of a method of sending a coupon, which could be implemented by the smart media system shown in FIG. 2, steps comprise:

In step S501, the mobile terminal 30 sends a coupon request to server 10 for receiving the coupon of an associated media device 20.

In step S502, the server 10 searches the coupon mark associated with the device based on the device mark of the associated media device 20 provided by the coupon request.

In step S503, the server 10 searches and retrieves the coupon related to the coupon mark.

In step S504, the server 10 sends the coupon to the mobile terminal 30.

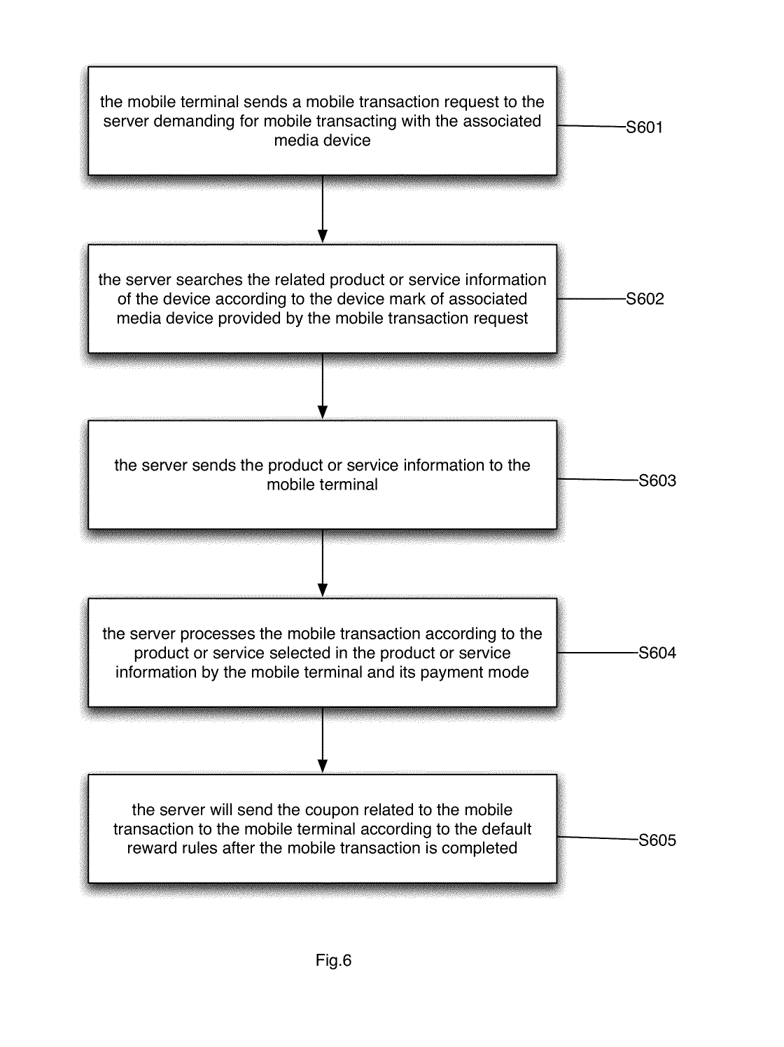

FIG. 6 is the flowchart of an embodiment of a method for processing mobile transactions, which could be implemented by the smart media system shown in FIG. 2, steps comprise:

In step S601, the mobile terminal 30 sends a mobile transaction request to the server 10 for mobile transacting with the associated media device 20.

In step S602, the server 10 searches the related product or service information of the device based on the device mark of associated media device 20 provided by the mobile transaction request.

In step S603, the server 10 sends the product or service information to the mobile terminal 30.

In step S604, the server 10 processes the mobile transaction based on the product or service selected by the mobile terminal 30 and on the selected payment mode.

The mobile transaction may further comprise:

If the media device 20 has a vending module 24 installed, the server 10 may send a product dispense command to the vending module 24 of media device 20. The server 10 confirms the mobile transaction and charges the mobile terminal 30 for the transaction fees when the vending module 24 confirms that the dispensing of the product is completed.

If delivery is selected as the method of fulfillment, the server 10 will send the purchase and delivery information to retailer system. The server 10 confirms the mobile transaction and charges the mobile terminal 30 for the transaction fees when the retailer system confirms that the product delivery is scheduled.

If a customer selects a voucher as a means of fulfillment of services or products mode, the server 10 may send the purchase information to the retailer's system. The server 10 confirms the mobile transaction and charges the mobile terminal 30 for the transaction fees when the retailer's system confirms that the retailer's system has sent the electronic voucher to the mobile terminal 30 or the voucher is printed by the vending module 24 of the media device 20.

step S605, the server 10 sends the coupon related to the mobile transaction to the mobile terminal 30 according to the predefined reward rules after the mobile transaction is completed.

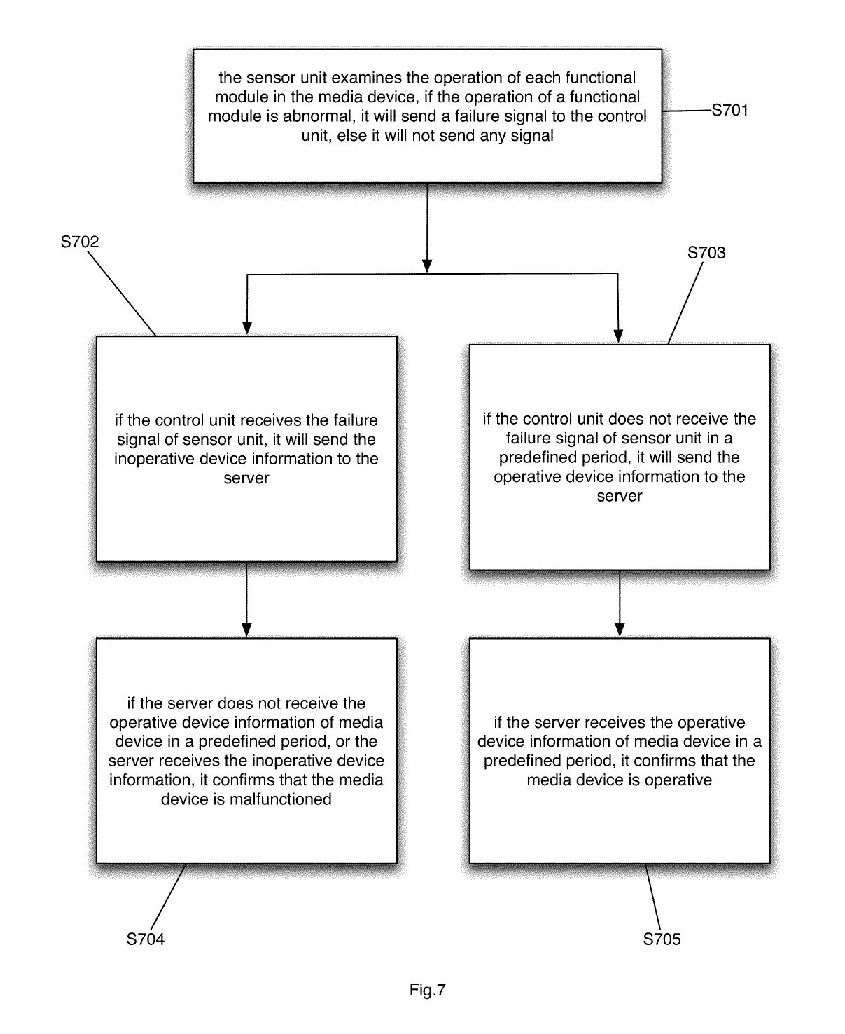

FIG. 7 is the flowchart of an embodiment of a method for monitoring the media device that could be implemented by the smart media system shown in FIG. 2. The media device 20 comprises a monitor module 25 that may be comprised of at least one sensor unit 251 and a control unit 252. Steps in accordance with the flow comprise:

In step S701, the sensor unit 251 examines the operation of each functional module in the media device 20. If the operation of a functional module is abnormal, sensor unit 251 sends a failure signal to the control unit 252, or else sensor unit 251 will not send any signal.

In step S702, if the control unit 252 receives the failure signal of sensor unit 251, control unit 252 sends the inoperative device information to the server 10.

In step S703, if the control unit 252 does not receive the failure signal of sensor unit 251 in a predefined period, control unit 252 sends the operative device information to the server 10.

In step S704, if the server 10 receives the operative device information of media device 20 in a predefined period of time, server 10 confirms that the media device 20 is operative.

In step S705, if the server 10 does not receive the operative device information of media device 20 in a predefined period, or the server 10 receives the inoperative device information, server 10 confirms that the media device 20 has malfunctioned.

The sensor unit 251 comprises the light sensor, circuit sensor and/or humidity sensor, the step S701 further comprises:

The light sensor receives the light producing information of media device 20. The light sensor sends a failure signal to the control unit 252 if the light producing information is abnormal;

The circuit sensor receives the circuit signal of each functional module of media device 20. The circuit sensor sends a failure signal to the control unit 252 if the circuit producing information is abnormal, and/or the humidity sensor examines the humidity inside the media device 20. The humidity sensor sends a failure signal to the control unit 252 if the humidity of media device 20 reaches the predefined humidity threshold.

Moreover, the media device 20 also comprises an electricity supply module 26 and a backup electricity module 27. If when examining the operation of electricity supply module 26 the results are abnormal, the sensor unit 251 sends an electricity supply failure signal to the control unit 252. The control unit 252 controls the backup electricity module 27 supplying electricity to the media device 20, via the backup electricity module 27 if electricity supply failure signal is received.

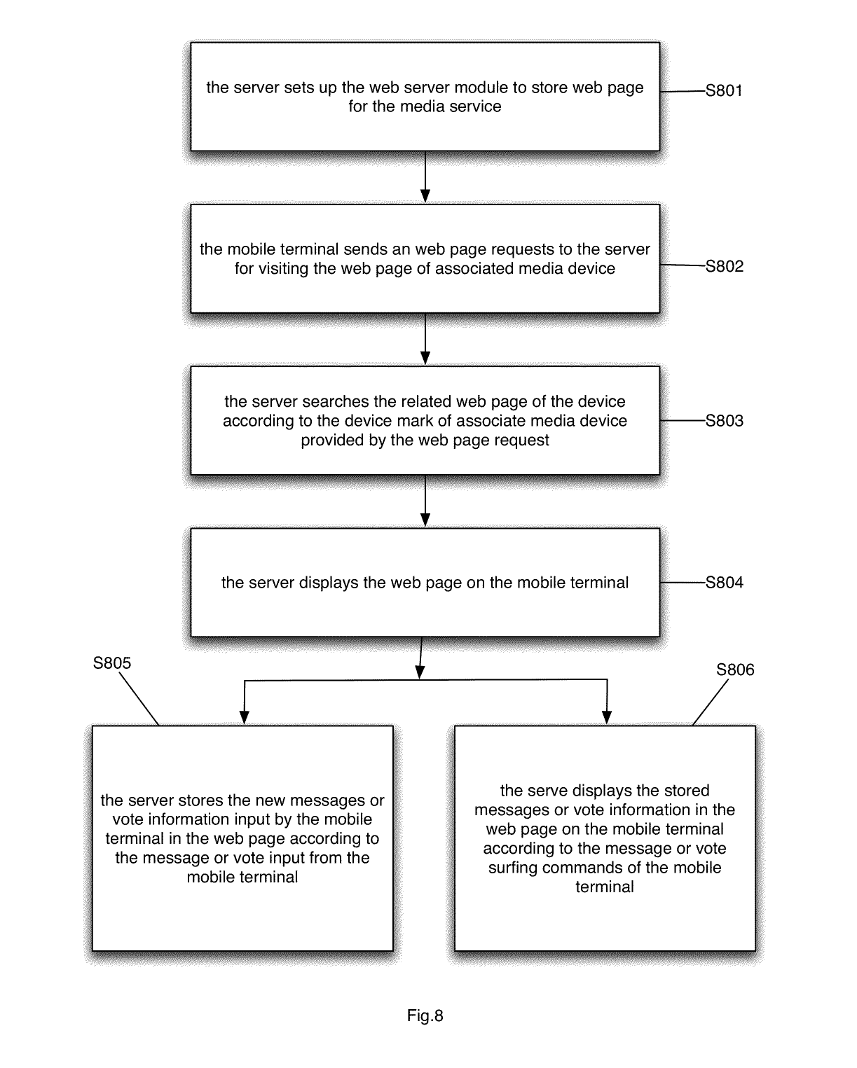

FIG. 8 is the flowchart of an embodiment of a method of visiting a webpage that could be implemented by the smart media system shown in FIG. 2, steps comprise:

In step S801, the server 10 sets up the web server module 15 to store the webpage for the media device 20. In an embodiment, the webpage is a webpage based on the Web2.0.

In step S802, the mobile terminal 30 sends a webpage request to the server 10 for visiting the webpage of the associated media device 20. Preferably, consumers are required to input an account and/or password for identification and verification when accessing the webpage via the mobile terminal 30.

In step S803, the server 10 searches the related web page of the device according to the device mark of the associated media device provided by the webpage request.

In step S804, the server 10 sends information required to generate the webpage to mobile terminal 30 (and mobile terminal 30 displays the webpage).

In step S805, the server 10 receives new messages or voting commands sent by the mobile terminal 30. If a vote command is received, server 10 computes the effect of the new vote. The server 10 stores in the webpage the message or the vote of the mobile terminal 30.

In step S806, the server 10 displays the stored messages or vote information in the webpage on the mobile terminal 30 according to the message or voting commands of the mobile terminal 30.

The embodiments of method 800 may be implemented in the following non-limiting circumstances:

Circumstance 1: When the media device 20 shows the commercial of a movie, after connecting to the associated media device 20, via the mobile terminal 30, consumers may leave messages on the movie commercial, such as the expectations of the movie, reviews of the movie, and/or tidbits of the shooting. Other consumers may surf the messages.

Circumstance 2: When the media device 20 is showing the commercial of a restaurant, after connecting to the associated media device 20, via the mobile terminal 30, consumers may leave messages on the restaurant commercial. Some examples of messages that may be left are comments about the food, service, and/or ambiance. The user may also upload the photos or videos of having a meal in the restaurant. Other consumers may surf the messages.

Circumstance 3: When the media device 20 is showing the commercial of a TV series, after connecting to the associated media device 20, via the mobile terminal 30, consumers may leave messages about the TV series commercial. Some examples of messages that users may leave are comments about leading roles, supporting roles, and/or the filming techniques. Furthermore, consumers may vote for which of multiple plots for the ending of the film they prefer. Other consumers may surf the messages.

Circumstance 4: When the media device 20 displays a commercial of a digital single lens reflex camera, after connecting to the associated media device 20, via the mobile terminal 30, consumers may leave messages about the camera commercial, such as the comments about lens, functions, and/or prices. Furthermore, consumers may also upload the photos or videos shot by the camera of the relevant model. Other consumers could surf the messages.

Circumstance 5: Consumers may access the web page of the media device 20, via the mobile terminal 30. The interactivity could be relevant or not relevant to the media information being sent by the associated media device 20. For example, when the media device 20 shows a commercial, consumers may access the web page of the media device 20, via the mobile terminal 30, to select the page related to the commercial to leave messages. As another example, consumers may access a city treasure hunt to join a quiz game about the hunt. The answers to the questions of the quiz may give hints to the next hunt to another media device 20.

In summary, the smart media system provides a personal media information sending technology in which a mobile terminal 30 selects the neighboring media device 20 as an associated media device proactively. Mobile terminal 30 interacts with the associated media device 20 without relying on RFID technology. Consumers may request the server for the detailed media information of associated media device, via a mobile terminal, instead of merely receiving the media information passively as the prior technology. The detailed media information provided by the smart media system is more effective and meets consumers' preferences. Also, the smart media system leads the mobile terminal to interact with the media device without relying on the RFID module. Not requiring RFID modules, not only lowers the cost, but also supports any kind of mobile terminal that is convenient for promoting to consumers and popularizing the smart media system function. In an embodiment, the smart media system adopts various kinds of methods for a mobile terminal to link with the media device. Having smart media system include multiple methods for mobile terminals to link with the media device overcomes the difficulty for the mobile terminal linking with the media device accurately as the prior arts outdoor positioning technology or the indoor positioning technology could not position accurately. In an embodiment, the smart media system also supports having the mobile terminal process a mobile transaction related to the associated media device and the server. The server sends coupons according to the requests and preferences of consumers, to the mobile terminal that enhances the commercial effectiveness of media devices. Moreover, the smart media system sets up a network based on the media device to encourage the consumers to be surfers and content contributors of the smart media, thereby enhancing the interactivity between the smart media system and the mobile terminal. Moreover, as the server of a smart media system monitors the operation of each media device, workers do not need to examine every device which could greatly lower the management and repair cost of media devices.

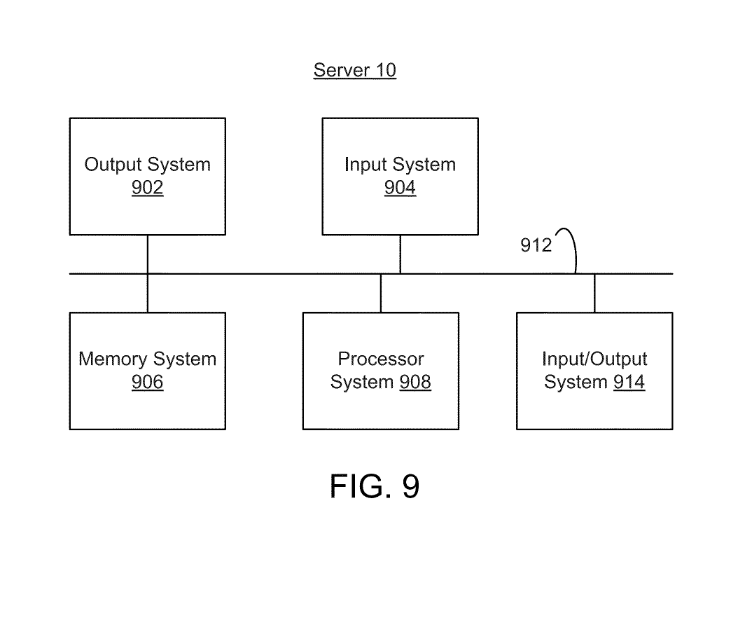

FIG. 9 shows a block diagram of an embodiment of the hardware of server 10 used in the smart media system of FIG. 1. The server 10 may include output system 902, input system 904, memory system 906, processor system 908, communications system 912, and input/output device 914. In other embodiments, server 10 tray include additional components and/or may not include all of the components listed above.

Server 10 is an example of a computer that may be used for the server 10.

Output system 902 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 904 may include any one of, some of any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 906 may include, for example, any one of some of, any combination of, or all of a long term storage system, such as a hard drive; a short term storage system, such as random access memory; a removable storage system, such as a floppy drive or a removable drive; and/or flash memory. Memory system 906 may include one or more machine-readable mediums that may store a variety of different types of information. The term machine-readable medium is used to refer to any non-transient medium capable of carrying information that is readable by a machine. One example of a machine-readable medium is a non-transient computer-readable medium. Another example of a machine-readable medium is paper having holes that are detected that trigger different mechanical, electrical, and/or logic responses. Memory 906 stores machine instructions for system management module 11, media management module 12, coupon module 13, transaction module 14, and/or web server module 15 and for implementing any of the tasks that server 10 performs in the methods of FIG. 3-8.

Processor system 908 may include any one of, some of any combination of, or all of multiple parallel processors, a single processor, a system of processors having one or more central processors and/or one or more specialized processors dedicated to specific tasks. Processor 908 carries out the methods of the machine instructions stored in memory 906.

Communications system 912 communicatively links output system 902, input system 904, memory system 906, processor system 908, and/or input/output system 914 to each other. Communications system 912 may include any one of some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 914 may include devices that have the dual function as input and output devices. For example, input/output system 914 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 914 is optional, and may be used in addition to or in place of output system 902 and/or input device 904.

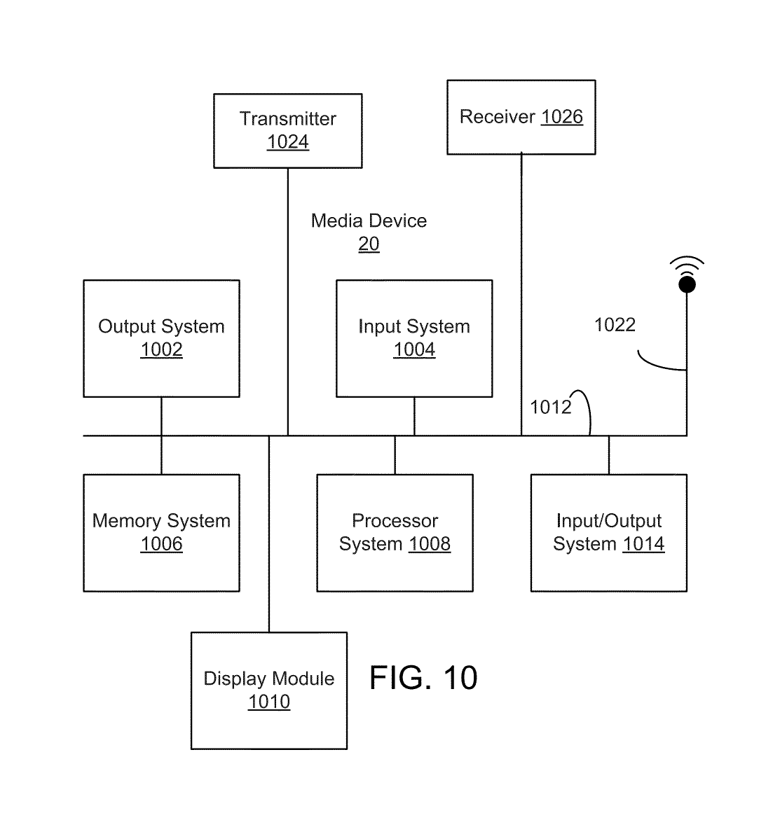

FIG. 10 shows a block diagram of an embodiment of the hardware of media device 20 used in the smart media system of FIG. 1. The media device 20 may include output system 1002, input system 1004, memory system 1006, processor system 1008, display module 1010, communications system 1012, input/output device 1014, antenna 1022, transmitter 1024, and receiver 1026. In other embodiments, server 10 may include additional components and/or may not include all of the components listed above.

Output system 1002, input system 1004, memory system 1006, processor system 1008, display module 1010, communications system 1012, and input/output device 1014 have the same or similar descriptions as output system 902, input system 904, memory system 906, processor system 908, display module 910, communications system 912, and input/output device 914, which were discussed in conjunction with FIG. 9. However, memory 1006 of FIG. 10 stores machine instructions for communication module 22, signal sending module 23, vending module 24, and monitor module 25. Memory 1006 stores machine instructions for implementing any of the tasks media device 20 performs in the methods of FIG. 3-8.

Display module 1010 is an embodiment of display module 21.

Antenna 1022 sends and receives signals. Although only one antenna is shown in FIG. 10, different antennas may be used for transmitting and receiving signals.

Transmitter 1024 processes the signal for sending the signal as electromagnetic waves, via a mobile phone network. Receiver 1026 processes incoming signals from a mobile phone network. Although FIG. 10 has a separate transmitter and receiver, in other embodiments, the transmitter and receiver may be replaced with a transceiver.

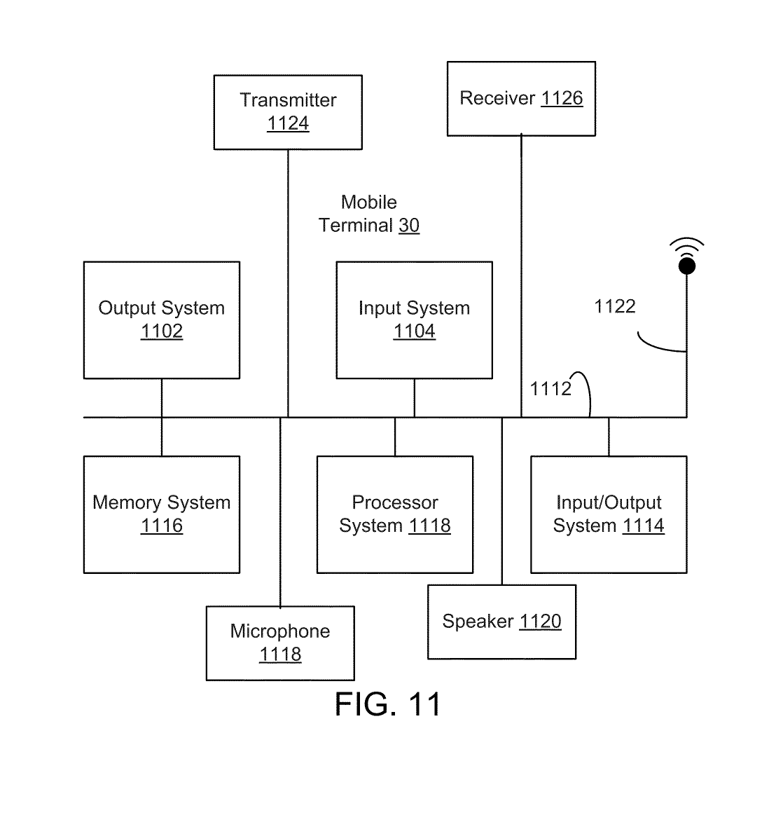

FIG. 11 shows a block diagram of an embodiment of the hardware of mobile terminal 30 used in the smart media system of FIG. 1. The mobile terminal 30 may include output system 1102, input system 1104, memory system 1106, processor system 1108, communications system 1112, input/output device 1114, microphone 1118, speaker 1120, antenna 1122, transmitter 1124, and receiver 1126. In other embodiments, mobile terminal 30 may include additional components and/or may not include all of the components listed above.

Output system 1102, input system 1104, memory system 1106, processor system 1108, communications system 1112, and input/output device 1114 of FIG. 11 have the same or similar descriptions as output system 902, input system 904, memory system 906, processor system 908, display module 910, communications system 912, and input/output device 914, which were discussed in conjunction with FIG. 9. Antenna 1122, transmitter 1124, and receiver 1126 have the same or similar description as antenna 1022, transmitter 1024, and receiver 1026, which were discussed in conjunction with FIG. 10. However, memory 1106 of FIG. 11 may include machine instructions for an application for interacting with server 10. Microphone 1118 may be used by the user for speaking into and/or picking up audio signals for sending over a mobile phone network. Speaker 1120 emits sounds from an incoming signal, which may be a recreation of a caller's voice.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention. There may be numerous embodiments in accordance with this invention. It is understood that the technicians of a related field could snake related amends and modifications in accordance with this invention but within the spirit and scope of this invention. Thus, the related amends and modifications are to be limited only by the claims as set forth below.

What is claimed is:

1. A method comprising:
disseminating, by a media device, media information;
sending, by the media device, a signal available to mobile terminals within a predefined location;
receiving, at the server, from the mobile terminal a request to view detailed media information associated with the media device;
searching, by the server, for the detailed media information associated with the media device, and
sending, by the server, the detailed information to the mobile terminal.

2. The method as set forth in claim 1, the signal sent by the media device including a device identifier of the media device and the request including the device identifier of the media device, wherein the searching for the detailed media information associated with media device, and the sending of the detailed media information to the mobile terminal comprises:
searching, by the server, for a media information identifier related to the device identifier of the media device provided by the request;
searching, by the server, for the detailed media information related to the media information identifier;
sending, by the server, the detailed media information to the mobile terminal.

3. The method of claim 1, wherein the method also comprises:
setting up information for populating an interface on the mobile terminal, by the server, the information being associated with the media device;
receiving, at the server, from the mobile terminal, a request to send the information for populating the interface to the mobile terminal, the request to send the information for populating the interface including an identifier of the media device;
searching, by the server, the information for populating the interface related to an identifier of the media device provided by the request;
sending, by the server to the mobile terminal, information that populates an interface on the mobile terminal;
receiving, by the server, a new message having an update that updates the information for populating the interface;
updating, by the server, the information for populating the interface with the update, as updated information for populating the interface;
storing, by the server, the updated information for populating the interface.

4. The method of claim 3, the update including a vote.

5. The method of claim 1, wherein further comprising
searching for media devices in a predefined distance of the mobile terminal;
generating a list of media devices based on the search;
sending the list to the mobile terminal;
receiving from the mobile terminal a selection of one or more media devices in the media device list;
linking, by the server, the media devices selected to the mobile terminal as associated media devices.

6. The method of claim 1, wherein the media device is installed on a fixed platform.

7. The method of claim 1, wherein the media device is installed on a mobile. platform

8. The method of claim 1, wherein steps further comprise:
receiving, at the server from the mobile terminal, a request for a coupon associated with the media device, the request including an identifier of the coupon and an identifier of the media device associated with the coupon;
searching, by the server, for the identifier of the coupon based on an identifier of the media device provided by the request for the coupon;
retrieving, by the server, the coupon;
sending by, the server, the coupon to the mobile terminal.

9. The method of claim 1, wherein steps further comprise:
receiving from the mobile terminal, a request to perform a mobile transaction that is the associated with the media device, the request to perform the mobile transaction including a device identifier associated with the media device;
searching, by the server, product or service information associated with the device identifier associated with the media device provided by the mobile transaction request;
sending, by the server, the product or service information to the mobile terminal;
receiving, at the server, a selection of a product or service and a selection of a payment method;
processing, by the server, the mobile transaction according to the product or service selected and the payment method selected.

10. The method of claim 9, wherein steps of processing the mobile transaction comprises:
if the media device includes a vending module, the server sending a request to dispense the product or service to the vending module of media device;
receiving at the server, confirmation that the transaction is complete;
sending from the server to mobile device, a confirmation that the mobile transaction is complete and
charging, by the server, the mobile terminal a transaction fee.

11. The method of claim 9, wherein steps of processing the mobile transaction comprise:
receiving, at the server, a confirmation that the retailer system scheduled a delivery date for the product or service;
after receiving the confirmation, sending, by the server, a confirm of the mobile transaction and
charging the mobile terminal for transaction fees.

12. The method of claim 9, wherein steps of processing the mobile transaction comprise:
sending, by the server, sales information to the retailer system;
receiving a confirmation from the retailer system that a voucher was sent;
after receiving the confirmation that the voucher was sent, sending, by the server, a confirmation of the mobile transaction; and
charging the mobile terminal for the transaction fees.

13. A method of smart media as set forth in claim 9, wherein steps of processing the mobile transaction comprise:
after the mobile transaction is complete, sending, by the server to the mobile terminal, a coupon related to the mobile transaction based on predefined rules to awarding rewards.

14. The method of claim 13, wherein the media device comprises a monitor module; the monitor module comprises at least one sensor unit and a control unit:
the method further comprising:
detecting, by the sensor unit, characteristics of operations of one or more functional modules in the media device,
if the characteristics of the operations of at least one of the one or more functional modules is abnormal, sending a signal to the control unit indicating a failure of at least one or more functional modules;
if the control unit receives the signal indicating the failure, sending, by the control unit to the server, information indicating that the media device is not operative;
if the control unit does not receive the signal indicating the failure in a predefined period, sending, by the control unit to the server, information indicating that the media device is operative;
if the server receives the information indicating that the media device is operative within a predefined period of time, performing, by the server, a test confirming that the media device is operative;
if the server does not receive the information indicating that the media device is operative within a predefined period, or if the server receives the information indicating that the media device is inoperative, performing, by the server, a test confirming that the media device has malfunctioned.

15. The method of claim 13, wherein the sensor unit comprises a light sensor;
the detecting, by the sensor unit, characteristics of operations of one or more functional modules in the media device further comprising:
the light sensor detecting characteristics of light from the media device; if the characteristics of the light detected is abnormal, sending the information indicating that the media device is inoperative.

16. The method of claim 13, wherein the sensor unit comprises a circuit sensor;
the detecting, by the sensor unit, characteristics of operations of one or more functional modules in the media device further comprising:
receiving, at the circuit sensor, a signal generated by one or more functional modules of the media device;
if characteristics of signal generated by one or more functional modules is abnormal, sending, by the control unit to the server, a failure signal.

17. The method of claim 13, wherein the sensor unit comprises a humidity sensor;
the detecting, by the sensor unit, characteristics of operations of one or more functional modules in the media device further comprising:
detecting, by the humidity sensor, humidity inside the media device;
if the humidity of media device reaches the predefined humidity threshold, sending, by the control unit to the server, a failure signal.

18. The method of claim 13, wherein the media device also comprises an electricity supply module and a backup electricity module;
the detecting, by the sensor unit, characteristics of operations of one or more functional modules in the media device further comprising:
detecting, by the sensor unit, one or more characteristics of an electric signal from the electricity supply;
if the one or more characteristics of the electric signal is abnormal, sending, by the sensor unit, a failure signal to the control unit;
if the control unit receives the failure signal, the control unit controls the backup electricity module to supply electricity to the media device.

19. A smart media system comprising
a server and
at least one media device;
the media device includes at least
a display module that displays media information;
a communication module that communicates with the server and a mobile terminal;
the server includes at least
a processor system having one or more processors;
a memory system storing
a system management module, which includes one more machine instructions, which when implemented causes the processor system to manage the media device by at least storing and checking the status of the one or more one media devices;
a media information module, which includes one more machine instructions, which when implemented causes the processor system to store and search detailed media information associated with a media device and to send the detailed media information to the mobile terminal after receiving the information request.

20. A smart media system as set forth in claim 19, wherein the media information module includes one or more machine instructions, which when implemented causes the server to implement a method including at least
storing detailed information associated with a media device according to an identifier of the information and an identifier of the media device;
receiving a request for the detailed information, the request having the identifier of the detailed information associated with the media device and the identifier of the media device;
searching for the detailed information based on the identifier of the information and the identifier of the media device; and
sending, from the server to the mobile terminal, the detailed media information.

21. The smart media system of claim 19, wherein
the server stores one or more machine instructions for
setting up information for populating an interface on the mobile terminal, the information being associated with the media device, and
receiving, at the server, from the mobile terminal, a request to send the information for populating the interface to the mobile terminal, the request to send the information for populating the interface including an identifier of the media device;
searching the information for populating an interface based on an identifier of the media device and an identifier of a media device provided by a request for information for populating an interface;
the server further stores a new message from the mobile terminal in the information for populating an interface according to the message.

22. A smart media system as set forth in claim 19, the media device further comprises a signal sending module that sends a signal identifying the media device.

23. A smart media system as set forth in claim 19, wherein the media device is installed on a fixed platform.

24. A smart media system as set forth in claim 19, wherein the media device is installed on a mobile platform.

25. A smart media system as set forth in claim 19,
the server also comprises a coupon module, which includes one or more machine instructions, which when implemented cause the server to store and search for an identifier of a coupon and a device identifier related to the media device mark; and send a coupon to the mobile terminal.

26. A smart media system as set forth in claim 19,
the server also comprises a mobile transaction module, which includes one or more machine instructions, which when implemented causes the server to implement a method including at least
receiving, at the server, the request including an identifier of a media device;
storing and searching, by the server, product or service information related to the identifier of a media device;
sending, by the server to the mobile terminal, the product or service information, and
processing, at the server, the mobile transaction according to the product or service selected and a payment method selected.

27. A smart media system as set forth in claim 19, wherein the media device comprises a vending module, which includes one or inure machine instructions, which when implemented cases the server to implement a method including at least
sending, by the media device, a request to dispense a product;
receiving, at the media device from a vending module, a confirmation that the product was dispensed;
sending a confirmation, by the mobile transaction module, confirming that the mobile transaction is complete; and
charging the mobile terminal for the transaction fees.

28. A smart media system as forth in claim 26, wherein
sending, by the mobile transaction module, sales and delivery information to a retailer system;
receiving a confirmation from a retailer that the product is scheduled to be delivered;
sending, by the mobile transaction module, a confirmation confirming that the mobile transaction is complete; and
charging the mobile terminal for the transaction fees.

29. A smart media system as forth in claim 23, the method further comprising:
receiving a confirmation from a retailer that a voucher was sent;
sending, by the mobile transaction module, a confirmation confirming that the mobile transaction is complete; and
charging the mobile terminal for the transaction fees.

30. A smart media system as set forth in claim 23, wherein the mobile transaction module includes one or more machine instructions, which when implemented causes the media device to implement the following steps:
sending, by the media device to the mobile terminal, a coupon related to the mobile transaction according to predefined rules or awarding a reward rules after the mobile transaction is completed.

31. A smart media system as set forth in any of the claim 30, wherein the media device further comprises a monitor module; the monitor module comprises at least one sensor unit and a control unit;
the sensor unit detects one or more operations of one or more functional modules in the media device;
if the operation of a functional module of the one or more functional modules is abnormal, the sensor unit sends a failure signal to the control unit;
if the control unit receives the failure signal from the sensor unit, the control unit sends to the system management module of server, information indicating that the media device is inoperative;
if the control unit does not receive the failure signal from the sensor unit in a predefined period of time, the control unit sends to the system management module server information indicating that the media device is operative;
if the system management module receives the operative device information of the media device in a predefined period of time, the system management module confirms that the media device is operative;
if the system management module does not receive the information indicating that the media device is operative within a predefined period of time, or if the system management module receives information that the media device is inoperative, the server performs a test to confirm that the media device malfunctioned.

32. A smart media system as set forth in claim 31, wherein the sensor unit comprises a light sensor;
the light sensor detects a light signal from the media device;
the light sensor sends a failure signal to the control unit if the light signal is abnormal.

33. A smart media system as set forth in claim 31, wherein the sensor unit comprises a circuit sensor;
the circuit sensor receives a circuit signal from each module of media device;
the circuit sensor sends a failure signal to the control unit if the circuit signal is abnormal.

34. A smart media system as set forth in claim 31, wherein the sensor unit comprises a humidity sensor;
the humidity sensor measures humidity inside the media device;
the humidity sensor sends a failure signal to the control unit if the humidity of the media device reaches the predefined humidity threshold.

35. A smart media system as set forth in claim 28, wherein the media device also comprises an electricity supply module and a backup electricity module;
the sensor unit sends the electricity supply a failure signal to the control unit if the sensor detects that the operation of the electricity supply module is abnormal;
if the control unit receives the failure signal, the control unit controls the backup electricity module supplying electricity to supply the media device with electricity.
